(19) United States
(12) Patent Application Publication
(10) Pub. No.: US 2021/0047158 A1
(43) Pub. Date: Feb. 18, 2021

(54) Scissor Jack Ratchet Converter Apparatus

(71) Applicant: Neville West, Roselle, NJ (US)

(72) Inventor: Neville West, Roselle, NJ (US)

(21) Appl. No.: 16/541,580

(22) Filed: Aug. 15, 2019

(51) Int. Cl. B66F 3/12; B25B 13/46; B25B 23/00

(52) U.S. Cl. CPC B66F 3/12; B25B 23/0035; B25B 13/46

(57) ABSTRACT

A scissor jack ratchet converter apparatus for easier use of scissor jacks includes an adaptor body having an adaptor back side with a crank channel extending towards an adaptor front side. A mounting aperture extends through an adaptor top side, the crank channel, and an adaptor bottom side. The crank channel is configured to receive a crank head of a scissor jack. A mounting bolt is slidably engageable through the mounting aperture and configured to pass through a head aperture of the crank head. A nut is selectively engageable with the mounting bolt to secure the mounting bolt to the adaptor body. A socket receptacle is coupled to the adaptor front side of the adaptor body and has a square socket aperture extending towards the adaptor body and configured to receive a socket wrench.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to jack tools and more particularly pertains to a new jack tool for easier use of scissor jacks.

### BRIEF SUMMARY OF THE INVENTION

An embodiment of the disclosure meets the needs presented above by generally comprising an adaptor body having an adaptor top side, an adaptor bottom side, an adaptor front side, an adaptor back side, an adaptor left side, and an adaptor right side. The adaptor back side has a crank channel extending towards the adaptor front side. A mounting aperture extends through the adaptor top side, the crank channel, and the adaptor bottom side. The crank channel is configured to receive a crank head of a scissor jack. A mounting bolt is slidably engageable through the mounting aperture and configured to pass through a head aperture of the crank head. A nut is selectively engageable with the mounting bolt to secure the mounting bolt to the adaptor body. A socket receptacle is coupled to the adaptor front side of the adaptor body. The socket receptacle has a socket front side lying in a plane parallel with a plane of the adaptor front side. The socket front side has a square socket aperture extending towards the adaptor body and configured to receive a socket wrench.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a scissor jack ratchet converter apparatus according to an embodiment of the disclosure.

FIG. 2 is a bottom plan view of an embodiment of the disclosure.

FIG. 3 is a rear elevation view of an embodiment of the disclosure.

FIG. 4 is a side elevation exploded view of an embodiment of the disclosure.

FIG. 5 is a front elevation view of an embodiment of the disclosure.

### DETAILED DESCRIPTION OF THE INVENTION

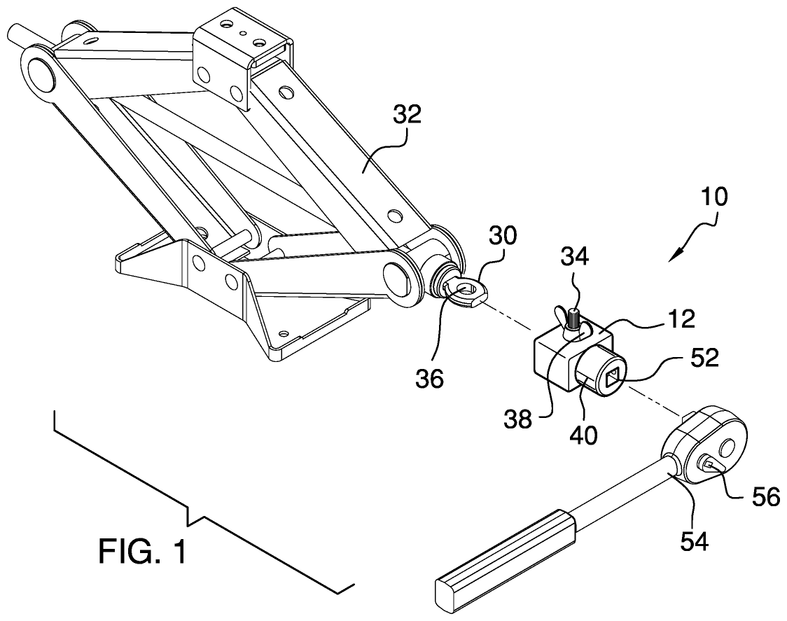

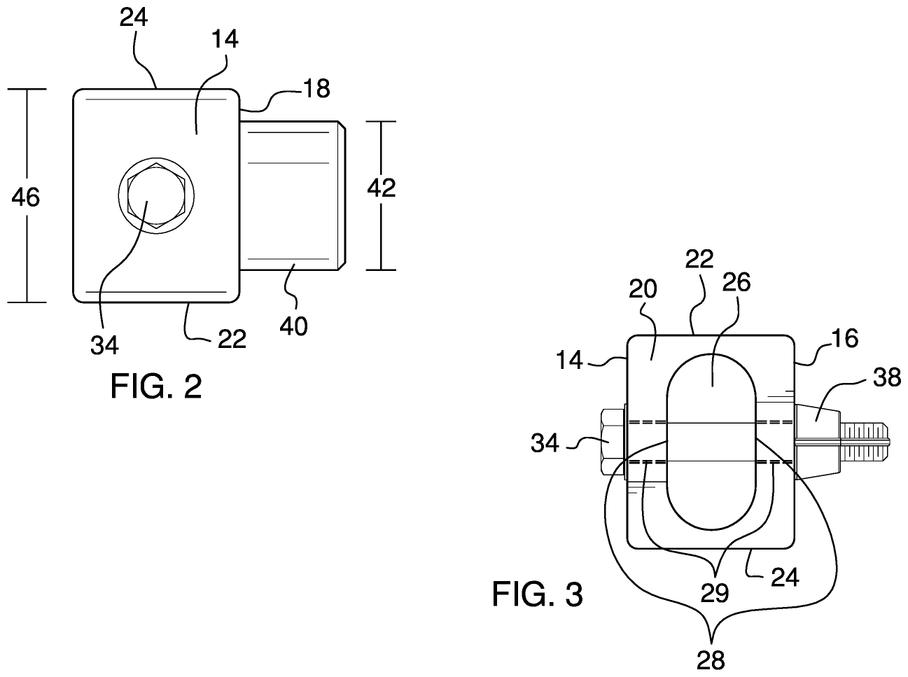

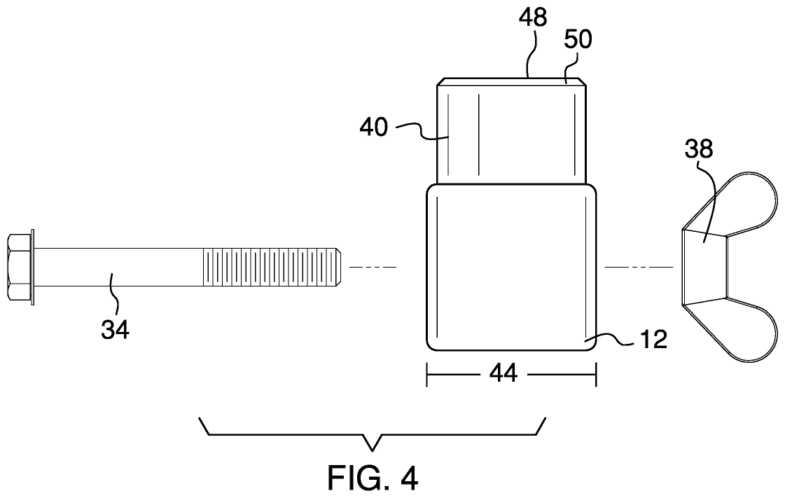

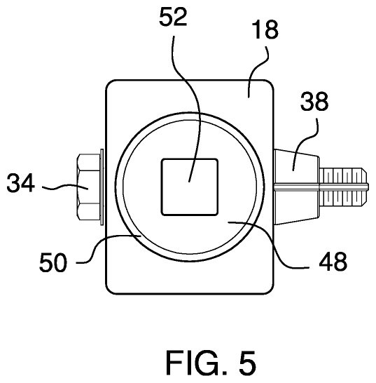

With reference now to the drawings, and in particular to FIGS. 1 through 5 thereof, a new jack tool embodying the principles and concepts of an embodiment of the disclosure and generally designated by the reference numeral 10 will be described.

As best illustrated in FIGS. 1 through 5, the scissor jack ratchet converter apparatus 10 generally comprises a rectangular prismatic adaptor body 12 having an adaptor top side 14, an adaptor bottom side 16, an adaptor front side 18, an adaptor back side 20, an adaptor left side 22, and an adaptor right side 24. The adaptor back side 20 has an obround crank channel 26 extending towards the adaptor front side 18. A mounting aperture 28 extends through the adaptor top side 14, the crank channel 26, and the adaptor bottom side 16. The mounting aperture 28 extends medially and perpendicularly through a pair of parallel flat edges 29 of the crank channel 26. The crank channel 26 is configured to receive a crank head 30 of a scissor jack 32.

A mounting bolt 34 is slidably engageable through the mounting aperture 28 and is configured to pass through a head aperture 36 of the crank head 30. A nut 38 is selectively engageable with the mounting bolt 34 to secure the mounting bolt 34 to the adaptor body 12 and thus the adaptor body 12 to the crank head 30. The nut 38 may be a wingnut to eliminate the need for tools during installation.

A socket receptacle 40 is coupled to the adaptor body 12. The socket receptacle 40 is cylindrical and coupled to the adaptor front side 18. The socket receptacle 40 has a diameter 42 substantially conforming to a height 44 of the adaptor body and less than a width 46 of the adaptor body to minimize the required size of the apparatus 10. The socket receptacle 40 has a socket front side 48 lying in a plane parallel with a plane of the adaptor front side 18. The socket front side 18 may have a chamfered edge 50 to prevent accidental injury or damage. The socket front side 18 has a square socket aperture 52 extending towards the adaptor body 12 and configured to receive a socket wrench 54.

In use, the adaptor body 12 is placed with the crank head 30 of the scissor jack within the crank channel 26. The mounting bolt 34 is slid through the mounting aperture 28 and the head aperture 36 of the crank head. The nut 38 is then tightened on to the mounting bolt 34. The socket aperture 52 may then be engaged with the socket wrench 54 to operate the scissor jack 32, utilizing a ratchet mechanism 56 of the socket wrench 54 for ease of use.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A scissor jack ratchet converter apparatus comprising:
an adaptor body, the adaptor body having an adaptor top side, an adaptor bottom side, an adaptor front side, an adaptor back side, an adaptor left side, and an adaptor right side, the adaptor back side having a crank channel extending towards the adaptor front side, a mounting aperture extending through the adaptor top side, the crank channel, and the adaptor bottom side, the crank channel being configured to receive a crank head of a scissor jack;
a mounting bolt, the mounting bolt being slidably engageable through the mounting aperture and configured to pass through a head aperture of the crank head;
a nut coupled to the mounting bolt, the nut being selectively engageable with the mounting bolt to secure the mounting bolt to the adaptor body; and
a socket receptacle coupled to the adaptor body, the socket receptacle being coupled to the adaptor front side, the socket receptacle having a socket front side lying in a plane parallel with a plane of the adaptor front side, the socket front side having a square socket aperture extending towards the adaptor body and configured to receive a socket wrench.

2. The scissor jack ratchet converter apparatus of claim 1 further comprising the crank channel being obround.

3. The scissor jack ratchet converter apparatus of claim 1 further comprising the adaptor body being rectangular prismatic and the socket receptacle being cylindrical.

4. The scissor jack ratchet converter apparatus of claim 3 further comprising the socket receptacle having a diameter substantially conforming to a height of the adaptor body and less than a width of the adaptor body.

5. The scissor jack ratchet converter apparatus of claim 3 further comprising the edges of the adaptor body being rounded.

6. The scissor jack ratchet converter apparatus of claim 3 further comprising the socket front side of the socket receptacle having a chamfered edge.

7. The scissor jack ratchet converter apparatus of claim 1 further comprising the nut being a wingnut.

8. A scissor jack ratchet converter apparatus comprising:
an adaptor body, the adaptor body being rectangular prismatic and having an adaptor top side, an adaptor bottom side, an adaptor front side, an adaptor back side, an adaptor left side, and an adaptor right side, the adaptor back side having an obround crank channel extending towards the adaptor front side, a mounting aperture extending through the adaptor top side, the crank channel, and the adaptor bottom side, the crank channel being configured to receive a crank head of a scissor jack;
a mounting bolt, the mounting bolt being slidably engageable through the mounting aperture and configured to pass through a head aperture of the crank head;
a nut coupled to the mounting bolt, the nut being selectively engageable with the mounting bolt to secure the mounting bolt to the adaptor body, the nut being a wingnut; and
a socket receptacle coupled to the adaptor body, the socket receptacle being cylindrical and coupled to the adaptor front side, the socket receptacle having a diameter substantially conforming to a height of the adaptor body and less than a width of the adaptor body, the socket receptacle having a socket front side lying in a plane parallel with a plane of the adaptor front side, the socket front side having a chamfered edge the socket front side having a square socket aperture extending towards the adaptor body and configured to receive a socket wrench.

9. A socket wrench and scissor jack ratchet converter apparatus combination comprising:
a socket wrench, the socket wrench having a socket;
an adaptor body, the adaptor body being rectangular prismatic and having an adaptor top side, an adaptor bottom side, an adaptor front side, an adaptor back side, an adaptor left side, and an adaptor right side, the adaptor back side having an obround crank channel extending towards the adaptor front side, a mounting aperture extending through the adaptor top side, the crank channel, and the adaptor bottom side, the crank channel being configured to receive a crank head of a scissor jack;
a mounting bolt, the mounting bolt being slidably engageable through the mounting aperture and configured to pass through a head aperture of the crank head;
a nut coupled to the mounting bolt, the nut being selectively engageable with the mounting bolt to secure the mounting bolt to the adaptor body, the nut being a wingnut; and
a socket receptacle coupled to the adaptor body, the socket receptacle being cylindrical and coupled to the adaptor front side, the socket receptacle having a diameter substantially conforming to a height of the adaptor body and less than a width of the adaptor body, the socket receptacle having a socket front side lying in a plane parallel with a plane of the adaptor front side, the socket front side having a chamfered edge the socket front side having a square socket aperture extending towards the adaptor body to receive the socket of the socket wrench.
